(19) United States
(12) Patent Application Publication
(10) Pub. No.: US 2008/0175559 A1
(43) Pub. Date: Jul. 24, 2008

(54) IMAGE PROCESS APPARATUS AND METHOD THEREOF

(75) Inventors: Min-woo Jung, Seoul (KR); Chun-un Kang, Seoul (KR); Ki-won Kwak, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/844,044

(22) Filed: Aug. 23, 2007

(30) Foreign Application Priority Data
Jan. 23, 2007 (KR) 2007-7003

(51) Int. Cl. H04N 5/91

(52) U.S. Cl. 386/68; 386/E05.003

(57) ABSTRACT

An image process apparatus and an image process method. The image process apparatus includes a receiving unit to receive moving picture data; and a buffering unit to preferentially buffer a predetermined number of frames by each frame group composing the moving picture data, thereby providing a continuous streaming picture.

### CROSS-REFERENCE TO RELATED APPLICATION

This application claims the benefit of Korean Application No. 2007-7003, filed in the Korean Intellectual Property Office on Jan. 23, 2007, the disclosure of which is incorporated herein by reference.

### BACKGROUND OF THE INVENTION

1. Field of the Invention

Aspects of the present invention relate to an image process apparatus and a method thereof and, more particularly, to an image process apparatus that provides continuous streaming images by preferentially buffering a predetermined number of frames, and a method thereof.

2. Description of the Related Art

Streaming technology allows moving picture data including audio/video to be sent and received in real-time over the Internet, without waiting to download the data. Streaming technology also enables the continuous processing of data information as the data is being downloaded in a sufficient amount to be processed, instead of processing the information after the information is fully downloaded. A user can directly play moving picture data without waiting until the entire moving picture data is downloaded, using a conventional image process apparatus. The moving picture data can be streamed or stored in a file so that a user can view and listen it anytime when the user desires.

A process of buffering the moving picture data is needed for streaming technology. In the aforementioned conventional image process apparatus, a predetermined amount of a first part of the moving picture data is buffered to be played. When the user sets a fast forward mode, it takes anywhere from a few seconds to several minutes to buffer the required moving picture data for the fast forward, depending on the bandwidth of a network. In a worst case scenario, the user will need to reconnect to the Internet.

Likewise, when a frame movement is set, a frame in a moved position is buffered after all previous frames are buffered. A buffering process taking anywhere from a few seconds to several minutes is needed to buffer the frame in the moved position, depending on the bandwidth of the network. In a worst case scenario, a network reconnection process is required, causing inconvenience to the user.

### SUMMARY OF THE INVENTION

Aspects of the present invention relate to an image process apparatus that provides continuous streaming images by preferentially buffering a predetermined number of frames and a method thereof.

Aspects of the present invention also relate to an image process apparatus that minimizes network traffic and a method thereof.

According to an aspect of the present invention, an image process apparatus is provided. The image process apparatus includes a receiving unit to receive moving picture data and a buffering unit to preferentially buffer a predetermined number of frames for each of a plurality of frame groups making up the moving picture data.

According to another aspect of the present invention, the image process apparatus may further comprise a calculating unit to calculate the number of frames to be buffered in each frame group, based on moving picture header information included in the moving picture data; wherein the buffering unit preferentially buffers the calculated number of frames in each frame group.

According to another aspect of the present invention, the calculating unit calculates the number of frames to be buffered using the following formulas:

BS=MS*(MB−NB)/MB

FN=Ceil(BS/(FS*GN))

If FN<1 then

FN=1

END IF

wherein BS is an amount of necessary buffering, MS is a size of the moving picture data, MB is a bandwidth of the moving picture data, NB is a bandwidth of network, FN is the number of frames to be buffered, FS is the number of frames, and GN is the number of frame groups (GOPs).

According to another aspect of the present invention, the buffering unit generates a frame index list by assigning an index number to each of the calculated number of frames.

According to another aspect of the present invention, the image process apparatus further includes an input unit to input a selection signal.

According to another aspect of the present invention, the image process apparatus further comprises a play unit to play the buffered frames in the order of the index number in the frame index list when the selection signal for setting a general play mode is input through the input unit, wherein the buffering unit buffers non-buffered frames when the play unit plays the buffered frames.

According to another aspect of the present invention, the image process apparatus further comprises a play unit to sequentially play the buffered frames in the order of the index number in the frame index list when the selection signal for setting a fast forward mode is input through the input unit.

According to another aspect of the present invention, the image process apparatus further comprises a play unit to preferentially play the frame in the moved position when the selection signal for setting a frame movement is input through the input unit and when a frame in a moved position is buffered, wherein the buffering unit may buffer the frame in the moved position if the frame in the moved position is not buffered.

According to another aspect of the present invention, an image process method is provided. The method comprises receiving moving picture data and preferentially buffering a predetermined number of frames for each of a plurality of frame groups making up the moving picture data.

According to another aspect of the present invention, the image process method further comprises calculating the number of frames to be buffered in one frame group, based on moving picture header information included in the moving picture data; wherein the buffering comprises preferentially buffering the calculated number of frames in each frame group.

According to another aspect of the present invention, the calculating comprises calculating the number of frames to be buffered using the following formulas:

BS=MS*(MB−NB)/MB

FN=Ceil(BS/(FS*GN))

If FN<1 Then

FN=1

END IF

wherein BS is an amount of necessary buffering, MS is a size of the moving picture data, MB is a bandwidth of the moving picture data, NB is a bandwidth of network, FN is the number of frames to be buffered, FS is the number of frames, and GN is the number of frame groups (GOPs).

According to another aspect of the present invention, the buffering comprises generating a frame index list by assigning an index number to each of the calculated number of frames.

According to another aspect of the present invention, the image process method further comprises playing the buffered frames in the order of the index number in the frame index list when a selection signal for setting a general play mode is input, wherein the buffering comprises buffering non-buffered frames when the playing is performed.

According to another aspect of the present invention, the image process method further comprises sequentially playing the buffered frames in the order of the index number in the frame index list when a selection signal for setting a fast forward mode is input.

According to another aspect of the present invention, the image process method further comprises preferentially playing the frame in the moved position when a selection signal for setting a frame movement is input and when a frame in a moved position is buffered, and wherein the buffering comprises buffering the frame in the moved position if the frame in the moved position is not buffered.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 a block diagram of an image process apparatus according to an embodiment of the present invention;

FIG. 2 is a block diagram of an image process apparatus according another embodiment of the present invention;

FIG. 3 is a schematic view explaining frames to be buffered according to another embodiment of the present invention;

FIGS. 4A, 4B, and 4C are schematic views explaining an image process technique according to another embodiment of the present invention;

FIG. 5 is a schematic view explaining an image process technique according to another embodiment of the present invention; and

FIGS. 6 through 10 are flow charts explaining image process techniques according to various embodiments of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

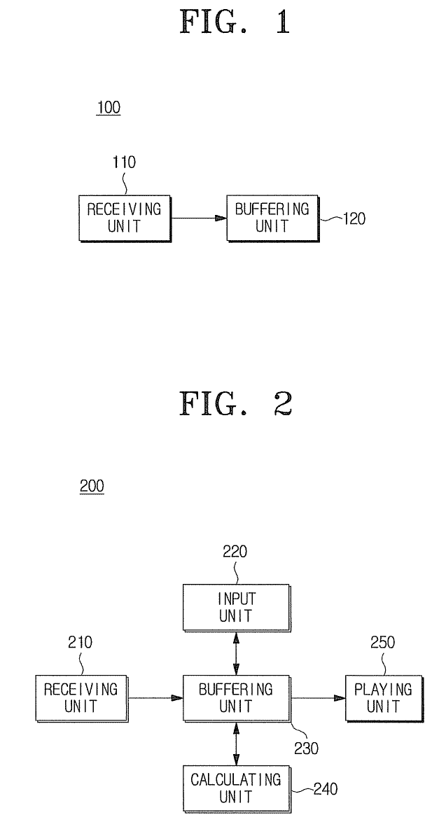

FIG. 1 is a block diagram of an image process apparatus 100 according to an embodiment of the present invention. The image process apparatus 100 comprises a receiving unit 110 and a buffering unit 120. The image process apparatus 100 according to other aspects of the present invention may include additional components; similarly, the functionality of the above units may be combined into a single unit. The image process apparatus 100 may be a desktop computer, portable computer, personal digital assistant, personal entertainment device, mobile telephone, etc, and can connect to a network using wireless and/or wired protocols.

The image process apparatus 100 analyzes moving picture header information included in moving picture data received by the receiving unit 110, parses the moving picture data, buffers the parsed moving picture data, and plays the moving picture data. The buffering unit 120 buffers the moving picture data according to selected signals. Examples of the signals include a play signal (an image replaying instruction), a stop signal, a pause signal, a fast forward signal, and a rewind signal.

The receiving unit 110 receives the moving picture data. The receiving unit 110 receives the moving picture data from a streaming server (not shown) and outputs the moving picture header information to the buffering unit 120. The moving picture header information is included in the received moving picture data.

The buffering unit 120 calculates an amount of the moving picture data needed to continuously play the moving picture data, and buffers the moving picture data based on the calculation. The buffering unit 120 can preferentially buffer a predetermined number of frames of each group of frames composing the moving picture data. A fixed value (for example, 1 to 2 for each group of frames) may be applied to the number of frames to be preferentially buffered, depending on the kind of the moving picture data. A value calculated based on the size of the moving picture data and/or other factors (such as the type of data, network conditions, etc.) may be used for the number of frames to be preferentially buffered. When the operations, such as play, fast forward, frame movement, and the like, are subsequently performed, the other frames that are not buffered (hereinafter, referred to as ‘non-buffered’) are buffered.

The frames composing the moving picture data are divided into groups, according to the characteristics of color or transition of the continuous frames composing the moving picture data. The groups of frames refers to a group of pictures (GOP), each group having a key frame and a plurality of normal frames. The key frame refers to a representative frame for each group. Additional factors may also be taken into account when dividing the moving picture data, and the groups can, in other aspects of the invention, be otherwise defined.

The frame refers to 25 to 30 frames per second that are displayed to give a sense of motion to each scene composing the picture in movie or TV screen. By way of example, about 30 frames are continuously displayed per second, to realize a moving picture. The number of frames per second is represented by frames per second (FPS). Generally, one frame of 256 colors and 640×480 resolution has a size of about 300 KB, calculated by 640×480×8+8. To embody the moving picture with the aforementioned amount of data, the amount of data for one minute is 300 KB×30 frames×60 seconds=540 MB. The size of the frames may vary depending on various factors, including compression techniques employed on the frames.

FIG. 2 is a block diagram of an image process apparatus 200 according to another embodiment of the present invention. The image process apparatus 200 comprises a receiving unit 210, an input unit 220, a buffering unit 230, a calculating unit 240 and a play unit 250. The image process apparatus 200 according to other aspects of the present invention may include additional components or may combine the functionality of one or more units into a single component.

The receiving unit 210 receives moving picture data. The input unit 220 receives various selection signals input by a user. The input unit 220 receives the selection signals being input by the user. Examples of the selection signals include a play signal (an image replaying instruction), a stop signal, a pause signal, a fast forward signal, and a rewind signal, as well as the selection signals for setting a general play mode, a fast forward mode, a frame movement, and the like. Frame movement is a signal to move to a particular frame(s), referred to as the frame in the moved position. The input unit 220 may be embodied by a remote controller, a control panel, a button provided at one side of the image process apparatus 220, or any device capable of receiving the user's input. While not required, the receiving unit 210 may receive the moving picture data using wired and/or wireless connections.

The buffering unit 230 preferentially buffers a predetermined number of frames for each group of frames making up the moving picture data. The buffering unit 230 preferentially buffers a calculated number of frames to be buffered for each group of frames through the calculating unit 240. If the number of frames to be buffered is FN, FN frames are preferentially buffered for each group of frames (GOP).

The buffering unit 230 generates a frame index list by assigning index numbers to the preferentially buffered frames. The index number indicates the position of each buffered frame in the moving picture data. The buffering unit 230 buffers non-buffered frames following the frame being played while the frame is played through the playing unit 250. If selection signal to set the frame movement to a frame in the moved position is received and the frame in the moved position is not buffered, the buffering unit 230 buffers the frame in the moved position.

The calculating unit 240 calculates the number of frames to be buffered in each group of the frames, based on the moving picture header information included in the moving picture data. The size of the moving picture data, the number of GOP (frame groups), the play time, and the like can be calculated by analyzing the moving picture header information.

While not required in all aspects, the calculating unit 240 may calculate the number of frames to be buffered using Formula 1:

BS=MS*(MB−NB)/MB

FN=Ceil(BS/(FS*GN))

If FN<1 Then

FN=1

END IF Formula 1

In Formula 1, BS is the amount of necessary buffering, MS is the size of moving picture data, MB is the bandwidth of the moving picture data, NB is the bandwidth of network, FN is the number of frames to be buffered, FS is the number of frames, and GN is the number of group of pictures (GOP). Ceil( ) is the ceiling function, a function that returns the smallest integer greater than or equal to the input value. The calculating unit 240 according to other aspects of the invention may calculate the number of frames to be buffered using other formulae.

A method of calculating the number of frames to be buffered will be described as an example below. When MS is 4 MB, MB is 1 MB/sec, NB is 500 KB/sec, FS is 25, GN is 4000, and these values are entered into Formula 1,

BS is 4M*(1M−500K)/1M=2M, and

FN is (200K/(25*4000))=20.

The calculating unit 240 calculates the number FN of frames to be buffered in the above-described manner and provides the calculated number FN to the buffering unit 230.

The calculating unit 240 rounds off the number of frames to be buffered, since buffering needs to be sufficiently secured. The number of frames in each group cannot be less than one, since the key frame in each group is unconditionally buffered. Therefore, if the number of frames to be buffered is less than 1, the number is defined as 1.

The play unit 250 plays the moving picture data. The play unit 250 plays the buffered frames at the play time. When the selection signal for setting the general play mode is input through the input unit 220, the play unit 250 plays the buffered frames in the order of the index number in the frame index list. While the buffered frames are played, non-buffered frames are buffered through the buffering unit 230, to provide a continuous streaming picture.

When the selection signal for setting the fast forward mode is input through the input unit 220, the play unit 250 sequentially plays the buffered frames in the order of the index number in the frame index list. Since all the key frames used upon fast forward are buffered, a continuous streaming picture is provided without any need for additional buffering.

When the selection signal for setting the frame movement is input through the input unit 220 and a frame in a moved position is buffered, the play unit 250 preferentially plays the frame in the moved position. If a frame prior to the frame played through the play unit 250 is not buffered, the moving picture data can be played without buffering the non-buffered previous frame.

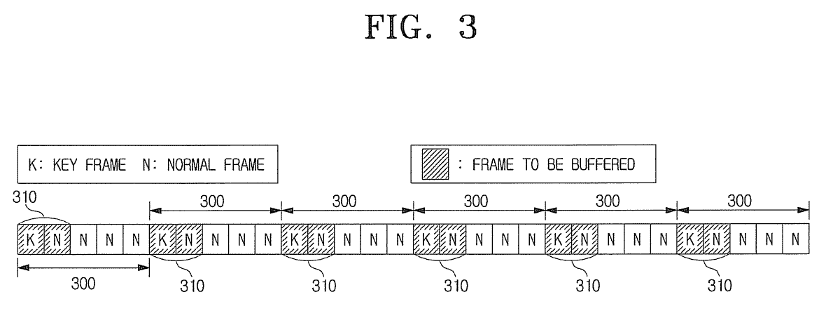

FIG. 3 is a schematic view explaining frames to be buffered according to another embodiment of the present invention. FIG. 3 shows a predetermined number of frames 310 to be preferentially buffered in each frame group (GOP) 300, as determined by the calculating unit 240. The moving picture data shown in FIG. 3 has 6 GOPs 300 and two frames to be preferentially buffered per GOP 300. The frame 310 to be buffered per group 300 includes one key frame and one normal frame.

As described above, the number of frames to be buffered may be a fixed default value or a value calculated by a formula such as Formula 1. In FIG. 3, the first two frames are preferentially buffered per GOP. However, the position of the frames to be preferentially buffered may be changed. For instance, if each GOP includes five frames, as shown in FIG. 3, only the third and fourth frames may be preferentially buffered, instead of the first and second shown in FIG. 3. Each GOP 300, although shown as having five frames in FIG. 3, may have any number of frames; similarly, the GOPs 300 need not all have the same number of frames.

When the frames to be preferentially buffered are buffered and the general play mode is set, the image process apparatus 100, 200 can provide a continuous streaming picture, since the non-buffered frames are buffered while the buffered frames 310 in each GOP 300 are played.

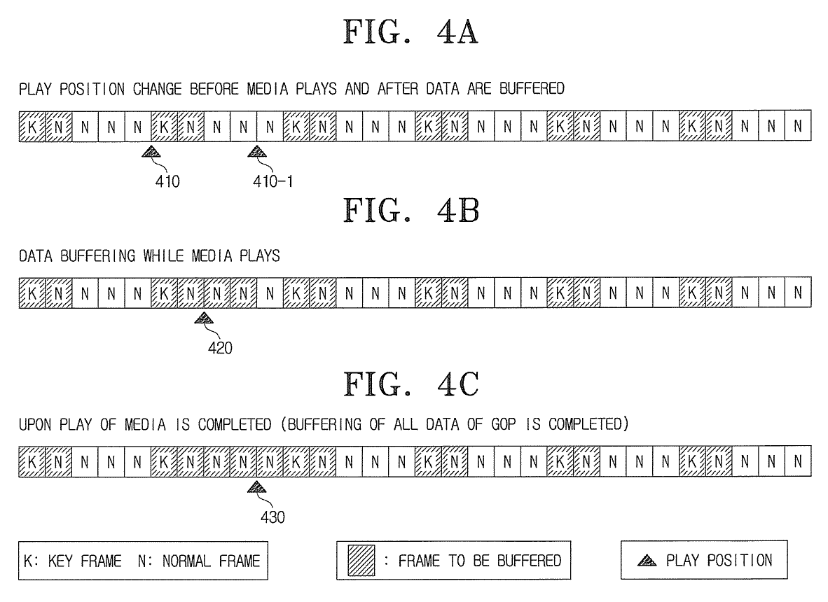

FIGS. 4A-4C are schematic views explaining an image process technique according to another embodiment of the present invention. FIG. 4A-4C show a predetermined number of frames preferentially buffered in the image process apparatus 100, 200 for each frame group of the moving picture data. When the frame movement is set and the frame of a play position 410 is buffered, the buffered frame is played. Non-buffered frames after the play position 410 are buffered. Accordingly, the non-buffered frames are all buffered while play positions 420 and 430 are moved, as shown in FIG. 4C.

As shown in FIG. 4A, the non-buffered frames are buffered when the frame movement is set and the frame of a play position 410-1 is not buffered. Since the non-buffered frames are buffered and the next frame is preferentially buffered, a time required for buffering the non-buffered frames is shortened as compared to the conventional manner. If the frame prior to the play position 410 at which the frame movement is set is not buffered, the non-buffered frames prior to the play position 410 are not buffered, minimizing network traffic.

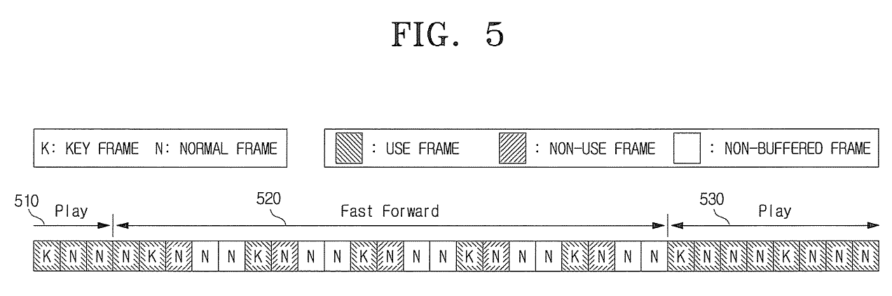

FIG. 5 is a schematic view explaining an image process technique according to another embodiment of the present invention. In FIG. 5, the fast forward mode is set in the image process apparatus 100, 200. The image process apparatus 100, 200 buffers the frames to be preferentially buffered. Index numbers are assigned to the buffered frames, and the buffered frames with the index numbers are recorded in the frame index list.

When the fast forward mode is set by a user during the general play 510, the fast forward 520 progresses. During the fast forward 520, only the key frames are played, based on the frame index list. When the general play mode is subsequently set by the user, the buffered frames at the point 530 at which the general play mode is played are played. While the buffered frames are played, the non-buffered frames are buffered to provide a continuous streaming picture.

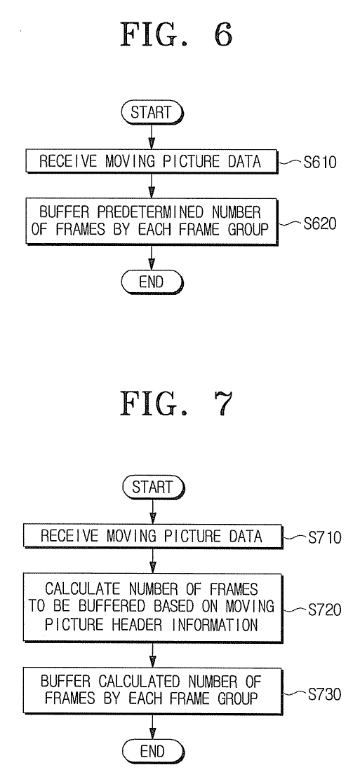

FIGS. 6 through 10 are flow charts explaining image process techniques according to various embodiments of the present invention. Referring to FIG. 6, the image process apparatus 100, 200 receives moving picture data, such as from a streaming server in operation S610. In operation S620, a predetermined number of frames are preferentially buffered for each frame group of the moving picture data. When the moving picture data are played, non-buffered frames in a group being played are buffered while the preferentially buffered frames are played, so as to provide a continuous streaming picture.

Referring to FIG. 7, the image process apparatus 100, 200 receives moving picture data from a streaming server in operation S710. In operation S720, the number of frames to be buffered is calculated based on moving picture header information included in the moving picture data. The number of frames to be buffered may be calculated using the Formula 1 described above. In operation S730, a calculated number of frames in each frame group are buffered.

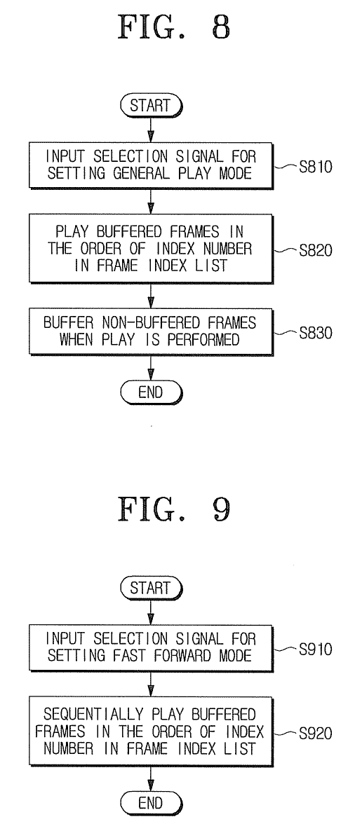

Referring to FIG. 8, a selection signal for setting a general play mode is input after a predetermined number of frames to be preferentially buffered for each frame group of moving picture data are buffered in operation S810. In operation S820, the image process apparatus 100, 200 plays the buffered frames in the order of an index number in the frame index list. In operation S830, non-buffered frames are buffered while the buffered frames are played. Accordingly, a continuous streaming picture is provided.

Referring to FIG. 9, a selection signal setting a fast forward mode is input after a predetermined number of frames to be preferentially buffered by each frame group of moving picture data are buffered in operation S910. In operation S920, the image process apparatus 100, 200 sequentially plays the buffered frames in the order of an index number in a frame index list. A continuous streaming picture is provided during the fast forward without any need for additional buffering, since all key frames used upon the fast forward are already buffered.

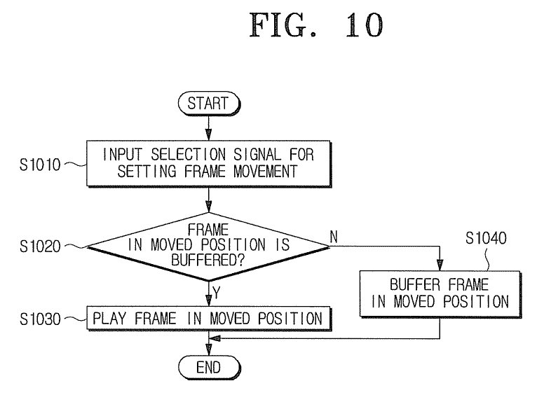

Referring to FIG. 10, a selection signal for setting a frame movement is input after a predetermined number of frames to be preferentially buffered by each frame group of moving picture data are buffered in operation S1010. If a frame in a moved position is buffered, the image process apparatus 100, 200 preferentially plays the frame in the moved position in operation S1030.

If the frame in the moved position is not buffered, the image process apparatus buffers the frame in the moved position in operation S1040. The buffering time is shortened as compared to a conventional manner, since only a predetermined number of frames in the moved position are buffered and the frames are preferentially buffered. Even though a frame prior to a played frame is not buffered, the image process apparatus can play the moving picture data without buffering the non-buffered frame. As a result, network traffic is minimized.

As described above, in accordance with the image process apparatus and the image process method according to aspects of the present invention, a predetermined number of frames are preferentially buffered, thereby providing a continuous streaming picture and minimizing network traffic. While described in terms of a network, it is understood that aspects of the invention can be used in non-network applications such as for media players buffered AV data read from an information storage medium. While described in terms of motion picture data, it is understood that aspects of the invention can be used with other data, such as audio, image, and/or software data, in addition to or instead of moving picture data.

Buffering techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image process apparatus comprising:
a receiving unit to receive moving picture data; and
a buffering unit to preferentially buffer, prior to playing back a plurality of frame groups of the moving picture data, a predetermined number of frames for each of the plurality of frame groups.

2. The image process apparatus of claim 1, further comprising:
a calculating unit to calculate a number of frames to be buffered in each frame group, based on moving picture header information included in the moving picture data;
wherein the buffering unit preferentially buffers the calculated number of frames in each of the frame groups.

3. The image process apparatus of claim 2, wherein the calculating unit calculates the number of frames to be buffered using the following formulas:
BS=MS*(MB−NB)/MB
FN=Ceil(BS/(FS*GN))
If FN<1 then
FN=1
END IF
wherein BS is an amount of necessary buffering, MS is a size of the moving picture data, MB is a bandwidth of the moving picture data, NB is a bandwidth of network, FN is the number of frames to be buffered, FS is the number of frames, and GN is the number of frame groups (GOPs).

4. The image process apparatus of claim 2, wherein the buffering unit generates a frame index list by assigning an index number to each of the calculated number of frames.

5. The image process apparatus of claim 4, further comprising:
an input unit to input a selection signal.

6. The image process apparatus of claim 5, further comprising:
a play unit to play the buffered frames in the order of the index number in the frame index list when the selection signal for setting a general play mode is input through the input unit,
wherein the buffering unit buffers non-buffered frames following the buffered frames while the play unit plays the buffered frames.

7. The image process apparatus of claim 5, further comprising:
a play unit to sequentially play the buffered frames in the order of the index number in the frame index list without buffering the remaining unbuffered frames when the selection signal for setting a fast forward mode is input through the input unit.

8. The image process apparatus of claim 5, further comprising:
a play unit to preferentially play the frame in a moved position when the selection signal for setting a frame movement is input through the input unit and when a frame in a moved position is buffered;
wherein the buffering unit buffers the frame in the moved position if the frame in the moved position is not buffered, without buffering an unbuffered frame preceding the frame in the moved position.

9. An image process method comprising:
receiving moving picture data; and
preferentially buffering, prior to playing back a plurality of frame groups of the moving picture data, a predetermined number of frames for each of the plurality of frame groups.

10. The image process method of claim 9, further comprising:
calculating the number of frames to be buffered in one frame group, based on moving picture header information included in the moving picture data;
wherein the buffering comprises preferentially buffering the calculated number of frames in each of the frame groups.

11. The image process method of claim 10, wherein the calculating comprises calculating the number of frames to be buffered using the following formulas:
BS=MS*(MB−NB)/MB
FN=Ceil(BS/(FS*GN))
If FN<1 Then
FN=1
END IF
wherein BS is an amount of necessary buffering, MS is a size of the moving picture data, MB is a bandwidth of the moving picture data, NB is a bandwidth of network, FN is the number of frames to be buffered, FS is the number of frames, and GN is the number of frame groups (GOPs).

12. The image process method of claim 10, wherein the buffering comprises generating a frame index list by assigning an index number to each of the calculated number of frames.

13. The image process method of claim 11, wherein the buffering comprises generating a frame index list by assigning an index number to each of the calculated number of frames.

14. The image process method of claim 12, further comprising:
playing the buffered frames in the order of the index number in the frame index list when a selection signal for setting a general play mode is input;
wherein the buffering comprises buffering non-buffered frames following the buffered frames while playing the buffered frames.

15. The image process method of claim 12, further comprising:
sequentially playing the buffered frames in the order of the index number in the frame index list without buffering the remaining unbuffered frames when a selection signal for setting a fast forward mode is input.

16. The image process method of claim 12, further comprising:
preferentially playing the frame in a moved position when a selection signal for setting a frame movement is input and a frame in a moved position is buffered;
wherein the buffering comprises buffering the frame in the moved position if the frame in the moved position is not buffered, without buffering an unbuffered frame preceding the frame in the moved position.

17. The image process method of claim 13, further comprising:
playing the buffered frames in the order of the index number in the frame index list when a selection signal for setting a general play mode is input; and
wherein the buffering comprises buffering non-buffered frames while playing the buffered frames.

18. The image process method of claim 13, further comprising:
sequentially playing the buffered frames in the order of the index number in the frame index list without buffering the remaining unbuffered frames when a selection signal for setting a fast forward mode is input.

19. The image process method of claim 13, further comprising:
preferentially playing the frame in the moved position when a selection signal for setting a frame movement is input and when a frame in a moved position is buffered;
wherein the buffering comprises buffering the frame in the moved position if the frame in the moved position is not buffered, without buffering an unbuffered frame preceding the frame in the moved position.

20. A method of minimizing network traffic involved in streaming data, the method comprising:
preferentially buffering a predetermined number of frames of data, including at least a key frame, for each of a plurality of frame groups making up the data;
receiving a command to fast forward through the data from a current position; and
displaying at least the preferentially buffered key frame, without displaying remaining unbuffered frames, in each of the frame groups so as to fast forward through the data.

21. A method of minimizing network traffic involved in streaming data, the method comprising:
preferentially buffering a predetermined number of frames of data, without buffering remaining frames, for each of a plurality of frame groups making up the data;
receiving a command to move to a selected frame of the data from a current frame;
reproducing the data starting at the selected frame if the selected frame is one of the buffered predetermined number of frames; and
buffering the selected frame prior to reproducing the data starting at the selected frame, without buffering preceding frames, if the selected frame is not one of the buffered predetermined number of frames.

22. A reproducing apparatus comprising:
a receiving unit to receive data;
a buffering unit to preferentially buffer a predetermined number of frames, without buffering a remaining frame, in each of a plurality of frame groups making up the data;
an input unit to receive input; and
a play unit to play the data based on the preferentially buffered frames and the input received from the input unit.

23. The reproducing apparatus of claim 22, wherein:
the play unit plays at least key frames included in each of the plurality of frame groups, without playing back the remaining unbuffered frames, when a command to fast forward is received through the input unit.

24. The reproducing apparatus of claim 22, wherein:
the buffering unit buffers a selected frame when a command to skip to the selected frame is received through the input unit and the selected frame has not been buffered, without buffering an unbuffered preceding frame; and
the play unit plays the data starting at the selected frame.

25. The reproducing apparatus of claim 22, wherein:
the play unit plays the data starting at a selected frame when a command to skip to the selected frame is input through the input unit and the selected frame has been buffered, and buffers the remaining frames of the frame group while the selected frame is played.

26. The reproducing apparatus of claim 22, further comprising:
a calculating unit to determine the number of predetermined frames per frame group to be buffered by the buffering unit, based on header data included in the data.

27. The reproducing apparatus of claim 22, wherein the predetermined frames in each frame group are adjacent to one another.

28. The reproducing apparatus of claim 22, wherein the predetermined frames in each frame group are not adjacent to one another.

29. A computer readable medium comprising instructions that, when executing by a reproducing apparatus, cause the reproducing apparatus to perform the method of claim 1.
